(19) United States
(12) Patent Application Publication
(10) Pub. No.: US 2025/0314312 A1
(43) Pub. Date: Oct. 9, 2025

(54) MULTI-PORT VALVE FOR CONTROLLING A MEDIUM

(71) Applicant: OTTO EGELHOF GmbH & Co. KG, Fellbach (DE)

(72) Inventors: Robin Bopp, Lorch (DE); Eike Willers, Stuttgart (DE)

(21) Appl. No.: 19/169,497

(22) Filed: Apr. 3, 2025

(30) Foreign Application Priority Data
Apr. 5, 2024 (DE) 10 2024 109 600.4
May 2, 2024 (DE) 10 2024 112 297.8
Mar. 5, 2025 (DE) 10 2025 108 332.0

(51) Int. Cl. F16K 11/07

(52) U.S. Cl. CPC F16K 11/0716

(57) ABSTRACT

Multi-port valve for controlling a medium in a refrigerant circuit of a refrigeration system. A stroke movement of the valve body along an axis is controllable by an actuating element of a drive. The valve body is tubular and extends along the stroke axis and, in a first end position of the stroke movement, passes through at least one first pressure chamber between an inlet and an outlet and at least one further pressure chamber between the inlet and at least one further outlet. At least one seal is associated with each pressure chamber for abutment against the valve body.

This application claims priority of German Application No. 10 2024 109 600.4 filed Apr. 5, 2024, German Application No. 10 2024 112 297.8 filed May 2, 2024, and German Application No. 10 2025 108 322.0, filed Mar. 5, 2025, all of which are incorporated herein by reference in their entireties.

The invention relates to a multi-port valve for controlling a medium, in particular in a refrigerant circuit of a refrigeration system with a heat pump function.

DE 10 2017 102 841 A1 discloses a multi-port valve for controlling a refrigerant circuit of a refrigeration system with heat pump function. This multi-port valve comprises a housing with an inlet which is connected to a fluid channel with a regulating chamber in the housing. Furthermore, the housing comprises a first and second outlet opening, which are also connected to the regulating chamber. A rotary slide valve arrangement is provided in the regulating chamber, which comprises a first control disk and a second control disk. At least the first control disk of the rotary slide valve arrangement is actuated by a drive, so that the first and/or second outlet opening can be controlled as required. The control disks of the rotary slide valve arrangement are made of a wear-resistant and low-friction material, such as ceramic. The requirements for a simple design and lower actuating forces as well as a reduction in the construction volume are constantly increasing.

The invention is based on the task of proposing a multi-port valve for controlling a medium, in particular in a refrigerant circuit of a refrigeration system with a heat pump function, which has a simple design and in which the valve can be actuated with low actuating forces.

This task is solved by a multi-port valve in which a drive is provided as well as a valve body whose stroke movement along a stroke axis is controllable by an actuating element of the drive. Furthermore, the multi-port valve comprises a valve body chamber facing the actuator, into which the valve body is at least partially moveable. The valve body is tubular and extends along the stroke axis, whereby the valve body, in at least one end position of its stroke movement, passes through at least one first pressure chamber between an inlet and a first outlet and projects into or passes through at least one second pressure chamber between the inlet and at least one further outlet, whereby at least one seal is assigned to each pressure chamber for contact with the valve body. This tubular design of the valve body, which communicates with the first and at least one second pressure chamber, makes it possible to create a simple and space-saving arrangement. In addition, this valve body enables low actuating forces to be required in order to move the tubular valve body from one end position to another end position and/or to intermediate positions for individual actuation of the pressure chambers.

It is preferable for the tubular valve body to have at least two flow openings, with a first flow opening being assigned to an inlet and at least one second flow opening being provided in the valve body, which is assigned to the one outlet and/or the at least one further outlet. This design makes it easy to connect the inlet to either the first outlet or the second outlet by activating a stroke movement of the valve body. It is also possible that the inlet can be connected to the first and the second outlet for mixed operation.

Preferably, a stop is provided for the stroke movement of the valve body in a first end position and in a second or further end position, in particular in the valve body chamber. This allows defined starting positions of the valve body to be assumed, from which the lifting movement is specifically controlled by the drive.

A pressure bypass is preferably provided between the valve body and the valve body chamber. This enables pressure equalization to be created so that a reduced actuating force of the actuator is possible when the valve body is moved from the first end position to the further end position. The tubular design of the valve body, which has at least a first and a second passage opening, makes it possible for the pressure of the medium to be present in the valve body chamber through the at least one passage opening, so that virtually no pressure difference counteracts an opening and closing movement or a movement of the valve body.

The seal assigned to at least one of the pressure chambers is preferably designed as a radial seal that rests against the outer circumference of the tubular valve body. As a result, a sufficient seal can be achieved on the one hand and an actuating movement of the valve body with reduced actuating forces on the other. In addition, the radial seal, which lies against the outer circumference of the valve body, can provide guidance. Alternatively, at least one seal assigned to the pressure chamber can be designed as an axial seal, which can come into contact with an end face of the tubular valve body. It may also be provided that at least one radial and at least one axial seal are provided, which are in sealing contact with the tubular valve body in at least one of the end positions. For example, it may be provided that a central seal is designed as a radial seal which surrounds the valve body and at least one seal arranged on the end face of the valve body is designed as an axial seal. The other seal assigned to the opposite end face of the tubular valve body can be designed as an axial seal or as a radial seal.

According to a preferred embodiment, a first seal is provided between the actuator and the first pressure chamber, a second seal is provided between the first pressure chamber and the second pressure chamber and a third seal is provided between the inlet and the second pressure chamber. This enables a simple design for a multi-port valve in which an inlet can be connected to two outlets as required. Preferably, a series is provided in such a way that a first outlet is provided downstream of an inlet and a second outlet is provided downstream of this.

In the above-described arrangement of the inlet, the first outlet and the second outlet, it is preferably provided that the tubular valve body has a length such that the valve body is guided within the first to third seals in a first end position and is guided only in the first and second seals in the second end position. This arrangement has the advantage that the overall length of the multi-port valve structure can be shortened. Alternatively, it may be provided that the valve body has a length such that in the first end position the valve body is guided in the first and second seals and is raised relative to the third seal and in a second end position it is guided only in the second and third seals and is raised relative to the first seal. In this embodiment, the valve body can be shorter than in the embodiment described above.

It may also be provided that the valve body has a length such that the valve body is guided by the second seal in the first and second end positions and the preferably second seal is designed as a radial seal and the first and third seal is designed as a radial and/or axial seal, wherein the valve body is lifted in the first end position relative to the first seal and is lifted in the second end position relative to the third seal.

Alternatively, it may be provided that the valve body has a length such that in the first end position the valve body is guided in the first and second seal and bears against the third seal in an axially sealing manner, and in the second end position it is only guided in the first and second seal and is lifted off the third seal.

In the aforementioned arrangement of the inlet, in the first outlet and the second outlet, it can alternatively be provided that the tubular valve body has a length so that the valve body is guided within the first to third seal both in the first end position and in the second end position. In this arrangement, a further passage opening is preferably provided in the circumferential wall and/or on an end face of the valve body in order to be able to control the individual switching positions.

According to an alternative embodiment, a first seal is provided between the actuator and the first pressure chamber, a second seal is provided between the inlet and the first pressure chamber and a third seal is provided between the inlet and the second pressure chamber. This alternative embodiment allows, for example, the inlet to be positioned between the first and second pressure chambers. In particular, this means that only laterally arranged line connections can be provided at a connection point in which at least two pressure chambers are provided.

In the aforementioned embodiment, it is preferably provided that the valve body extends from a passage opening assigned to the inlet on both sides in the direction of the at least one outlet in each case and is guided within at least three, in particular four, preferably radial seals.

According to a further preferred embodiment, it can be provided that the tubular valve body is round or oval when viewed in cross-section. In particular, the oval embodiment has the advantage that an anti-rotation device, which can be arranged in the valve body chamber, for example, is not required.

According to a further preferred embodiment of the multi-port valve, a first valve chamber sleeve is provided in association with the actuator, which extends in the opposite direction to the actuator and surrounds the valve body. This first valve chamber sleeve is associated with the first pressure chamber, with the first seal, which seals the pressure chamber to the actuator, being accommodated between the first valve chamber sleeve and the actuator. This arrangement has the advantage that the first seal is accommodated by the first valve chamber sleeve and can be inserted together with the actuator and the tubular valve body into an insertion opening of the connection point.

According to a further preferred embodiment, it is provided that the first valve chamber sleeve extends through the first pressure chamber and accommodates a second seal, which is arranged opposite the first seal adjacent to the first pressure chamber. This enables the chamber through which the valve body extends to be sealed on both sides and the outlet assigned to the first pressure chamber to be actuated depending on the position of the valve body's passage opening.

Furthermore, it is preferred that the second seal separates the first pressure chamber from the second pressure chamber or separates the first or second pressure chamber from the inlet. This depends on the positioning of the inlet to the first and second pressure chamber. This embodiment has the advantage that only one seal has to be provided, which forms a seal in the direction of both the first pressure chamber and the second pressure chamber or, in the alternative embodiment, a seal between the first pressure chamber and the inlet.

According to a further preferred embodiment, it is provided that the first valve chamber sleeve is adjoined by a second valve chamber sleeve which extends through the second pressure chamber, the first and second valve chamber sleeves being separated by a common second seal. This enables a simplified design.

Furthermore, it may preferably be provided that the second valve chamber sleeve has a third seal opposite the first valve chamber sleeve, which seals the second pressure chamber from the inlet. In this way, the second valve chamber sleeve, which can be inserted into the second pressure chamber, can seal the valve body extending through the second pressure chamber.

According to an alternative embodiment, it is provided that the second valve chamber sleeve has a third seal opposite the first valve chamber sleeve, which seals the second pressure chamber, into which the inlet opens, from a third pressure chamber that opens into the second outlet. This embodiment is preferably provided if the inlet is arranged between the two outlets.

Advantageously, it can be provided that the first and the at least second valve chamber sleeve is designed in one or more parts and at least one radial seal is accommodated in an interface between the at least two valve chamber sleeves or in an interface of the multi-part valve chamber sleeve or in an interface between the first valve chamber sleeve and the actuator. This arrangement allows the multi-port valve together with the valve chamber sleeves to form a so-called cartridge housing, which can be completely inserted into an insertion opening of the connection point.

Furthermore, it may preferably be provided that the first and at least one further valve chamber sleeve are non-detachably connected to each other. This allows a structural unit to be created in which the actuator is positioned together with the valve body in a fixed assignment to the valve chamber sleeves, so that defined positioning in the connection point is possible.

The invention and other advantageous embodiments and further embodiments thereof are described and explained in more detail below with reference to the examples shown in the drawings. The features to be taken from the description and the drawings can be used individually or in any combination in accordance with the invention. It shows:

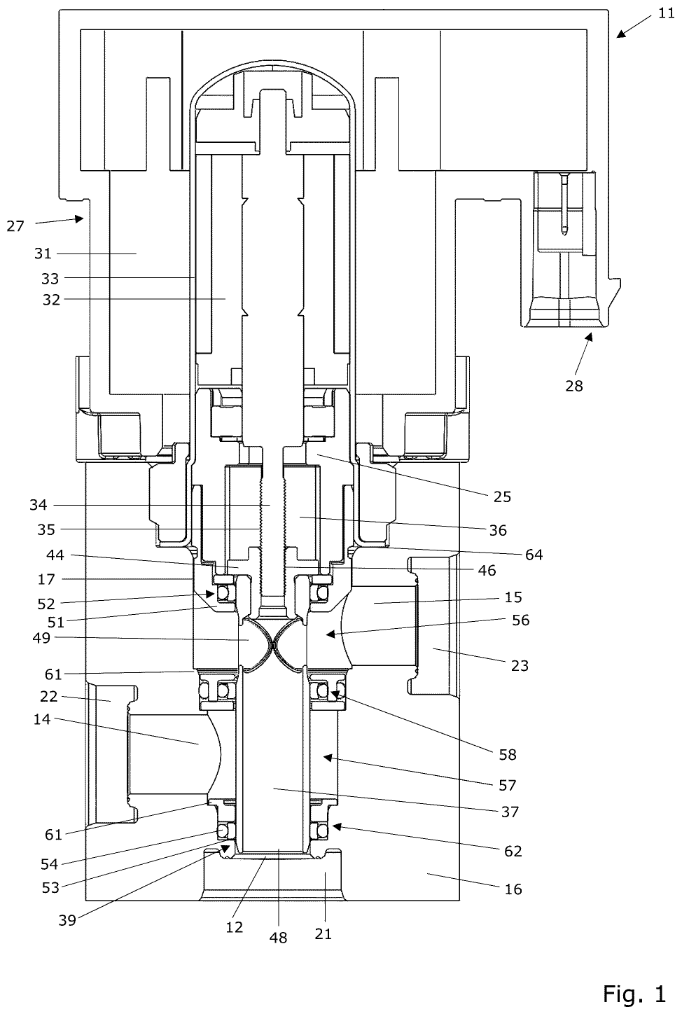

FIG. 1 a schematic sectional view of a multi-port valve in a first end position,

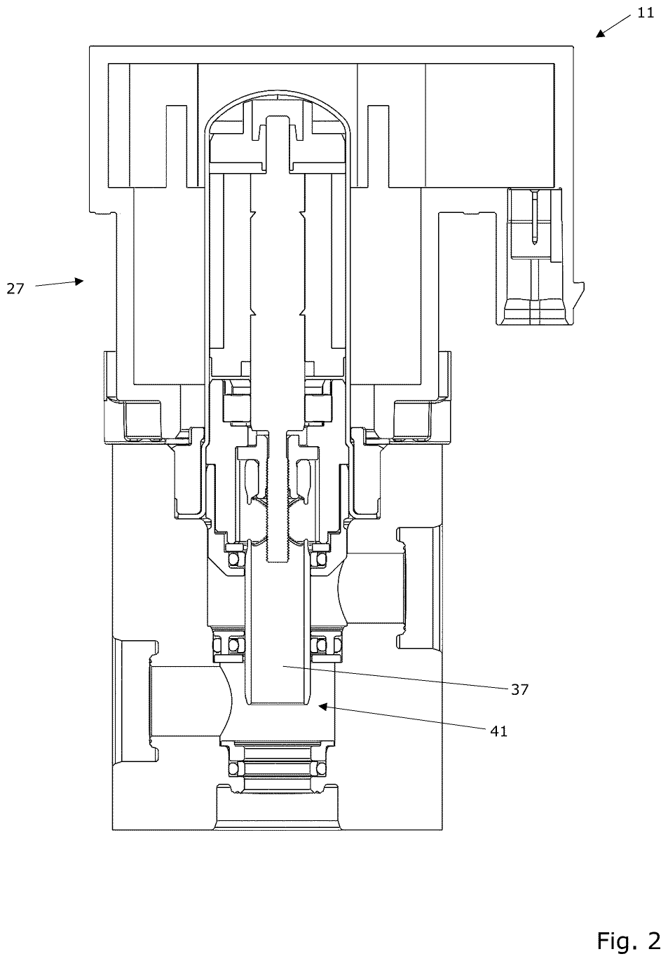

FIG. 2 a schematic sectional view of the multi-port valve according to FIG. 1 in a second end position,

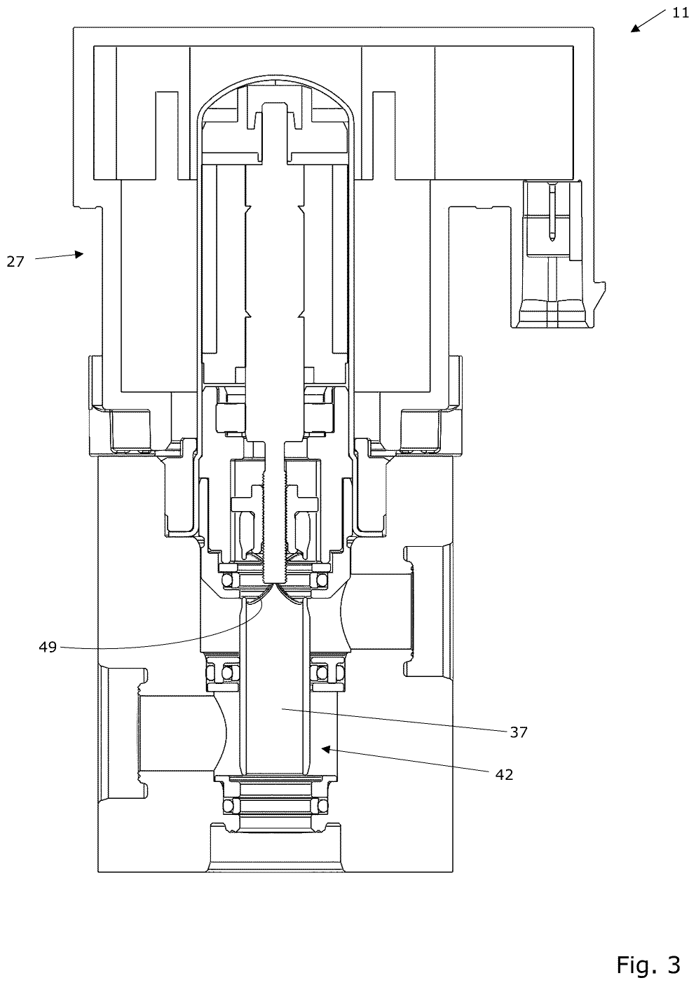

FIG. 3 a schematic sectional view of the multi-port valve according to FIG. 1 in an intermediate position,

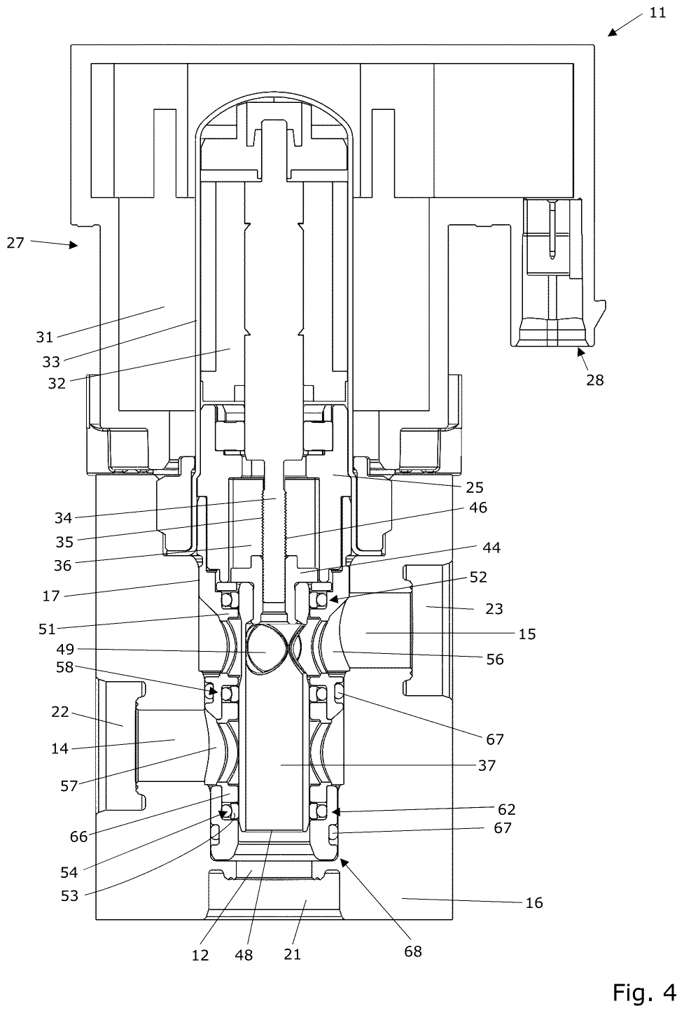

FIG. 4 a schematic sectional view of an alternative embodiment of the multi-port valve shown in FIG. 1 in a first end position,

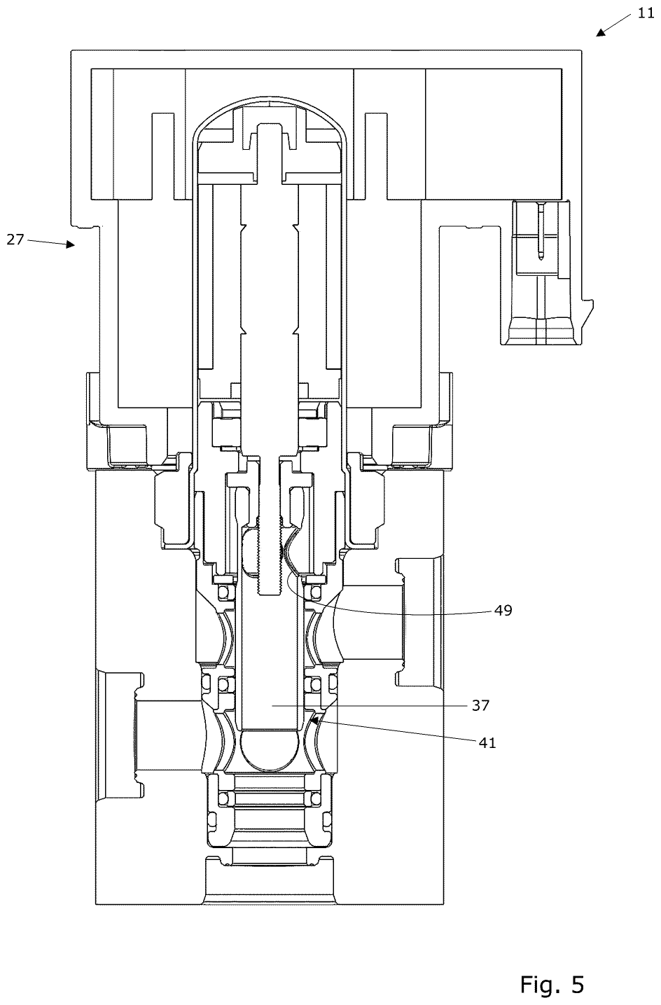

FIG. 5 a schematic sectional view of an alternative embodiment of the multi-port valve according to FIG. 4 in a second end position,

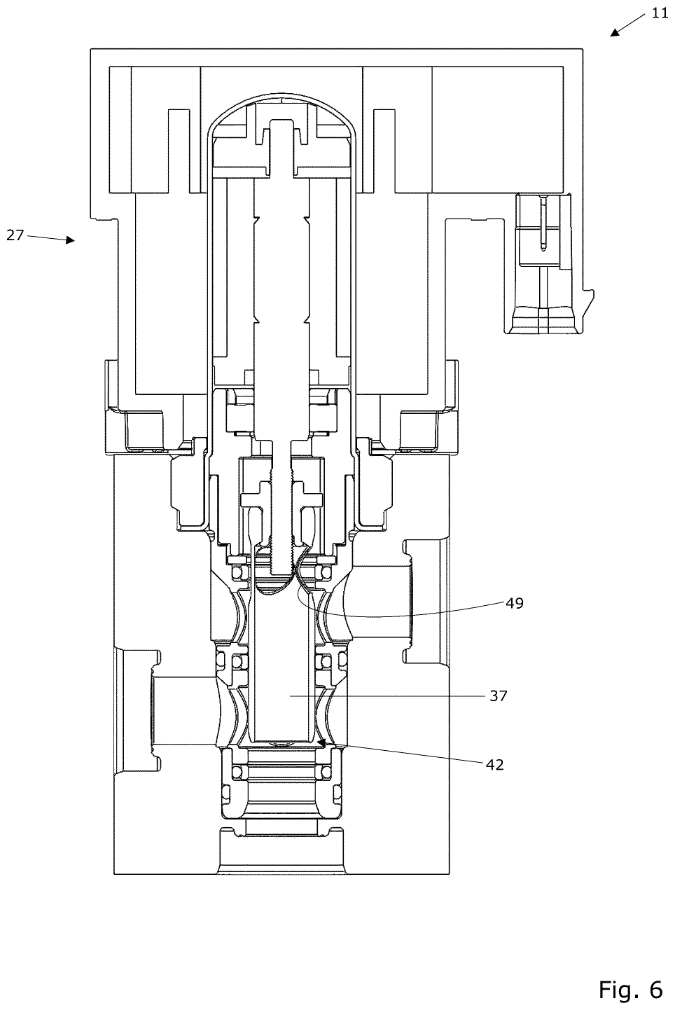

FIG. 6 a schematic sectional view of the alternative embodiment according to FIG. 4 in an intermediate position,

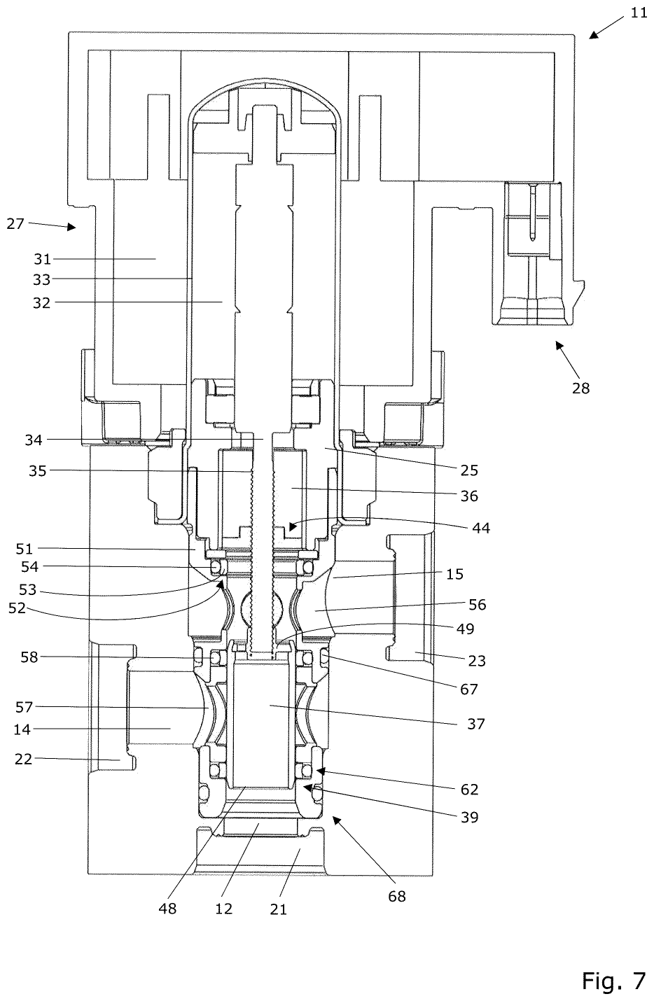

FIG. 7 a schematic sectional view of an alternative embodiment of the multi-port valve to FIG. 4 in a first end position,

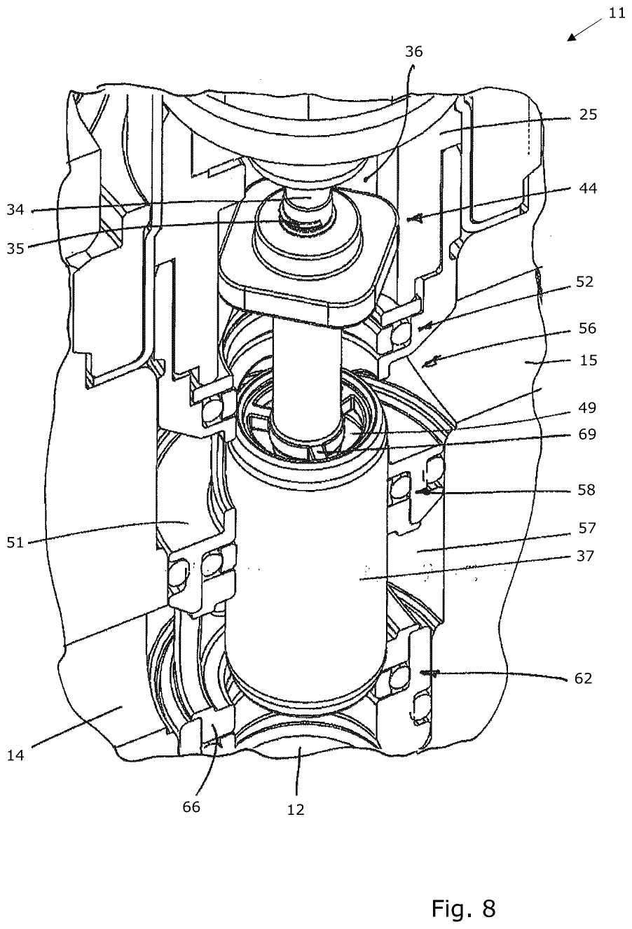

FIG. 8 a perspective view of a front end of the valve body as shown in FIG. 7,

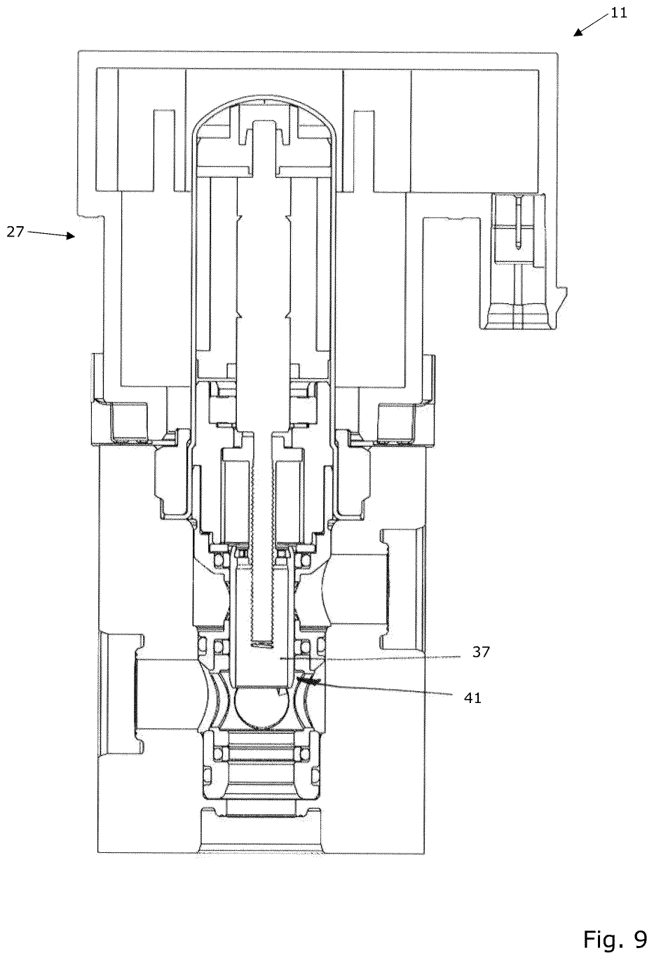

FIG. 9 a schematic sectional view of an alternative embodiment of the multi-port valve according to FIG. 4 in a second end position,

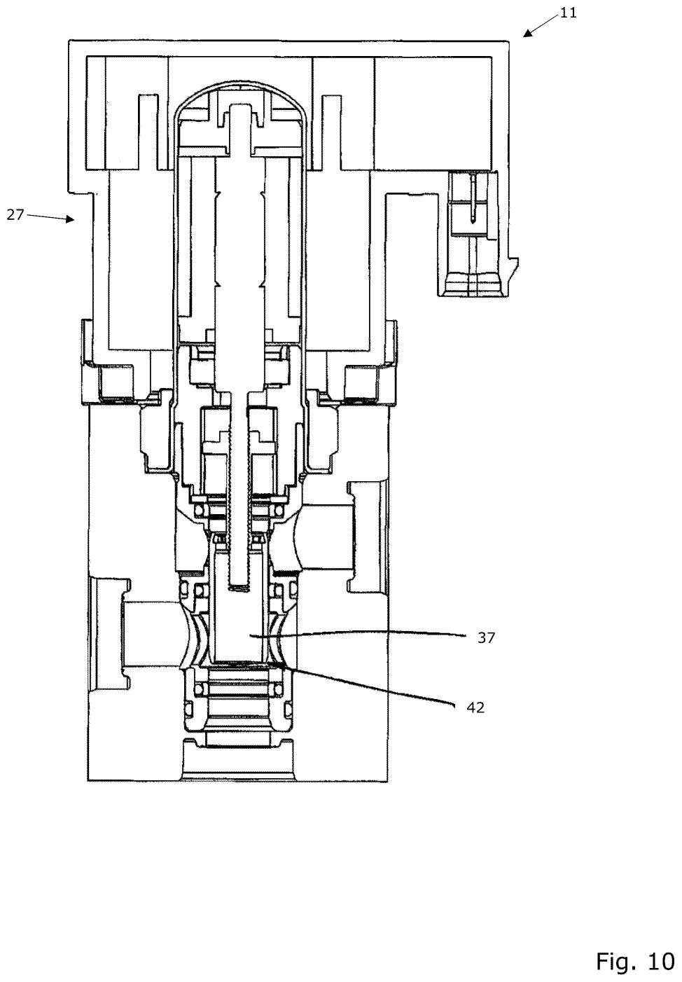

FIG. 10 a schematic sectional view of the alternative embodiment according to FIG. 4 in an intermediate position,

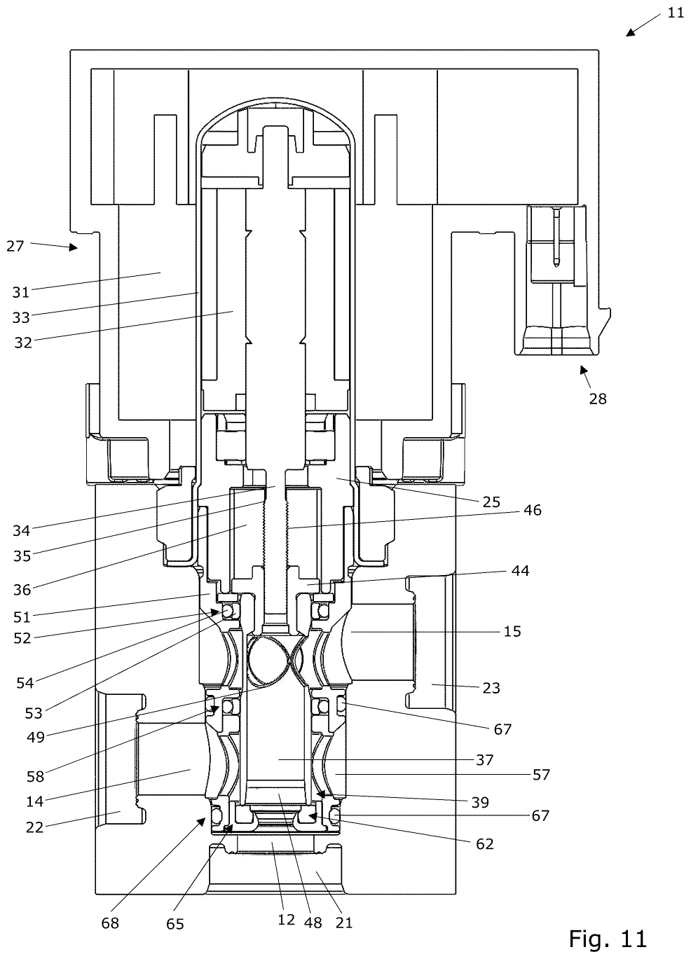

FIG. 11 a schematic sectional view of a further alternative embodiment of the multi-port valve shown in FIG. 4 in a first end position,

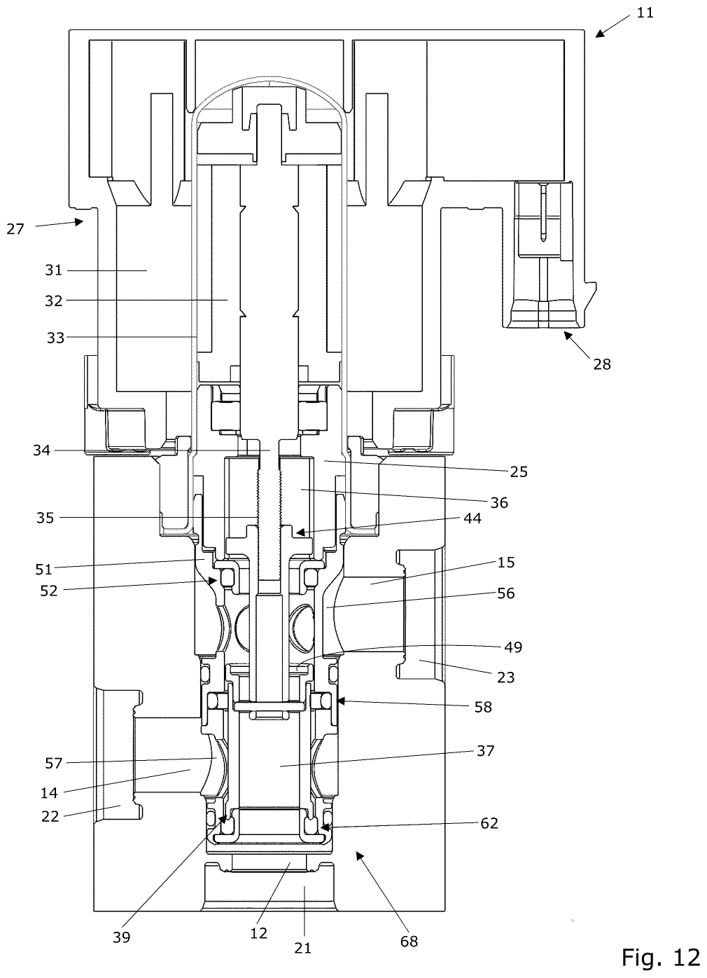

FIG. 12 a schematic sectional view of a further alternative embodiment of the multi-port valve to FIG. 7 in a first end position,

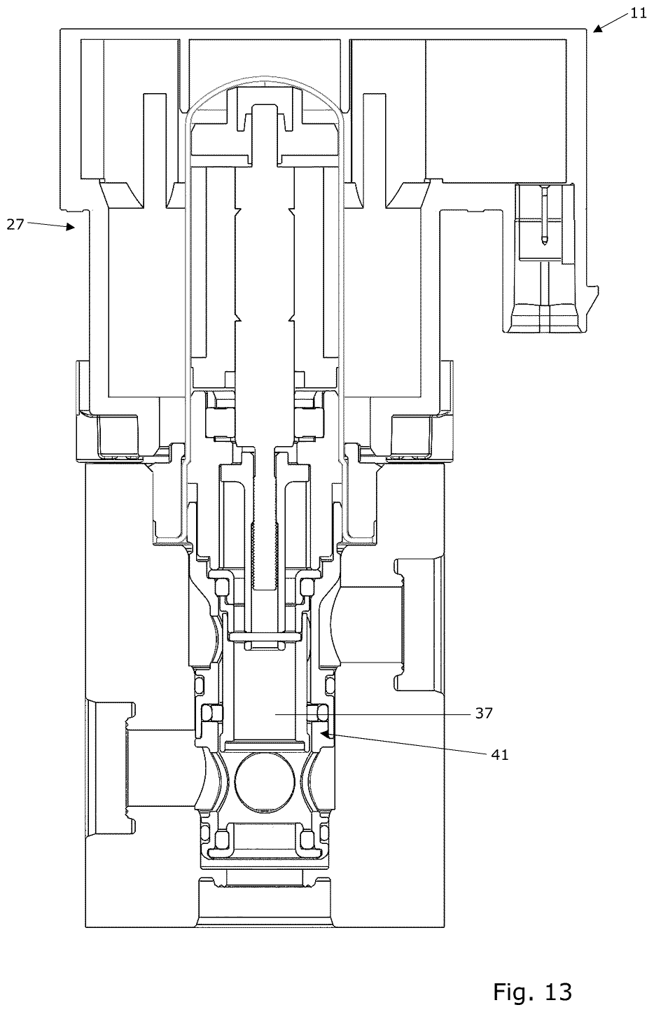

FIG. 13 a schematic sectional view of the alternative embodiment according to FIG. 12 in a second end position,

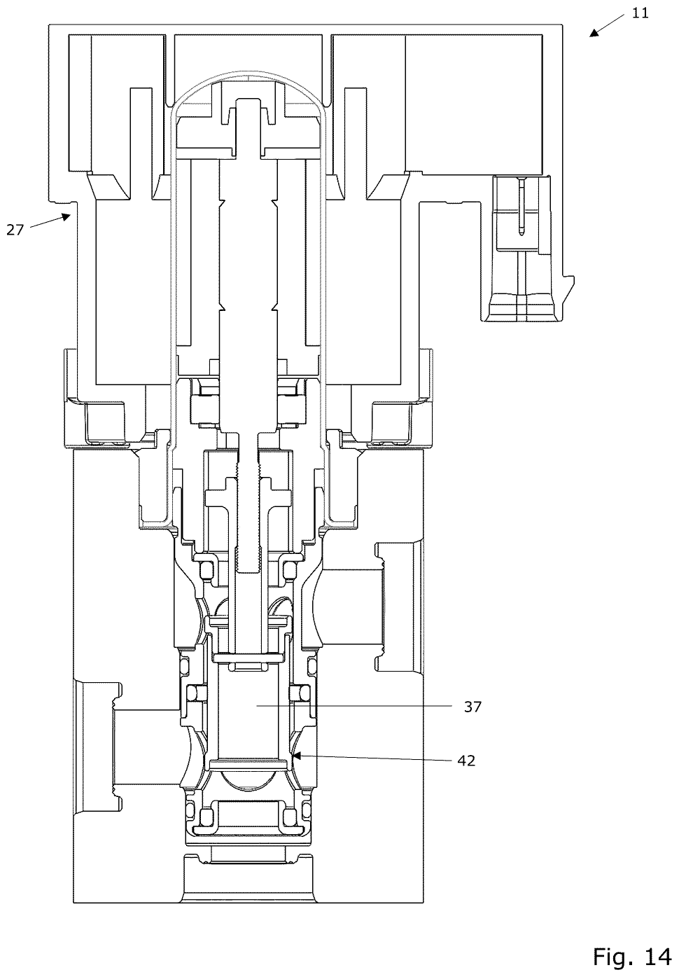

FIG. 14 a schematic sectional view of the alternative embodiment according to FIG. 12 in an intermediate position,

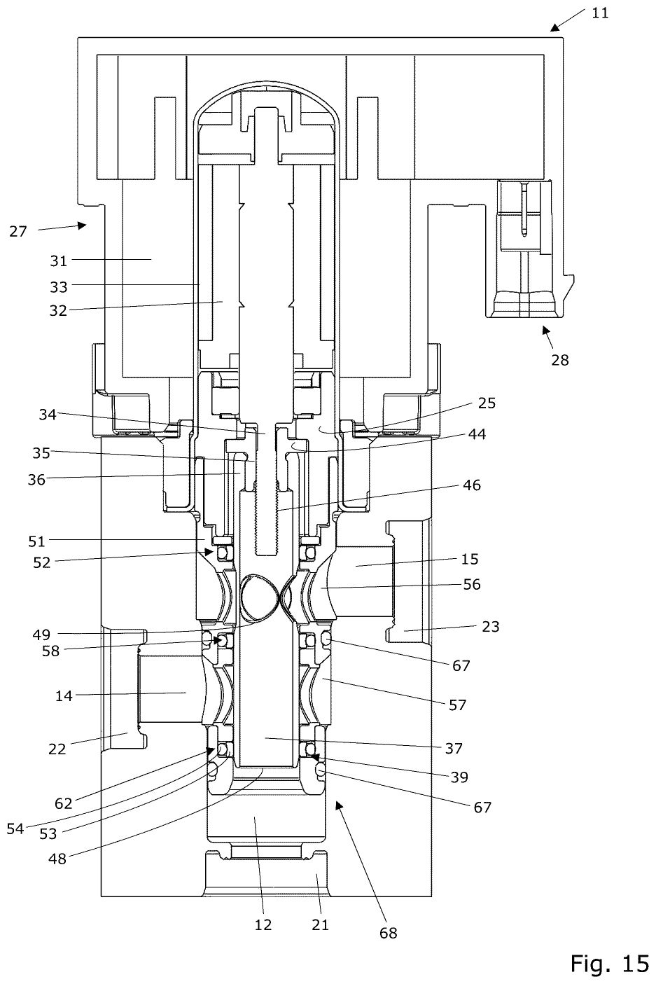

FIG. 15 a schematic sectional view of a further alternative embodiment of the multi-port valve shown in FIG. 4 in a first end position,

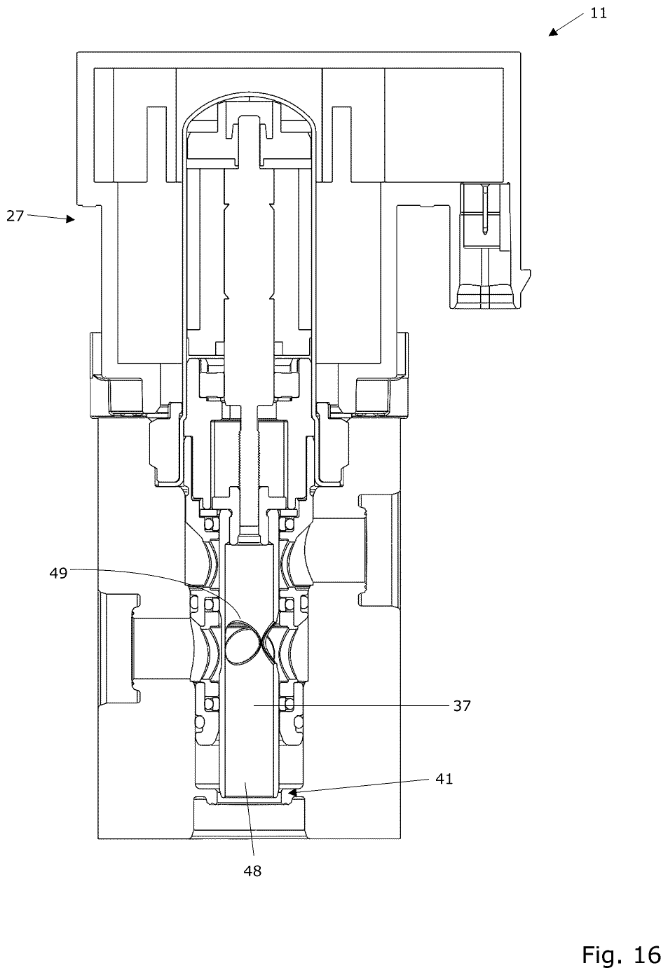

FIG. 16 a schematic sectional view of the alternative embodiment according to FIG. 15 in a second end position,

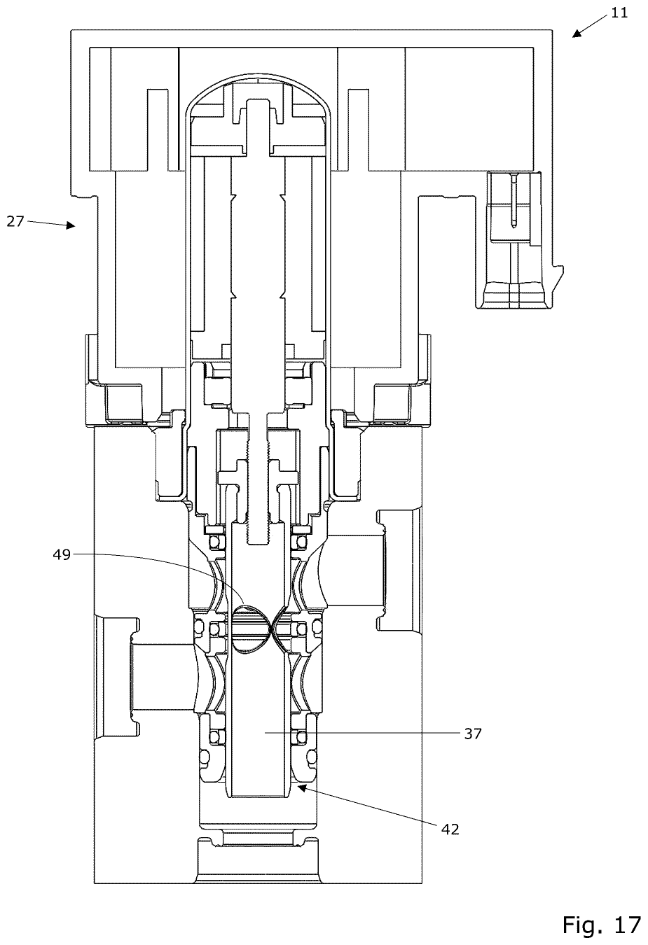

FIG. 17 a schematic sectional view of the alternative embodiment of the multi-port valve according to FIG. 15 in an intermediate position,

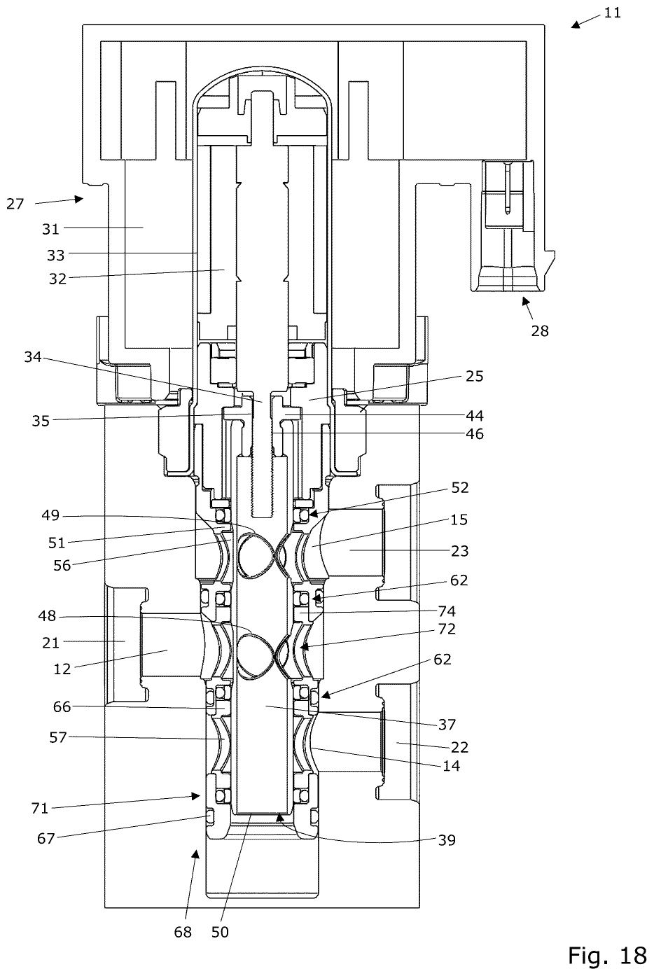

FIG. 18 a schematic sectional view of a further alternative embodiment of the multi-port valve shown in FIG. 4 in a first end position,

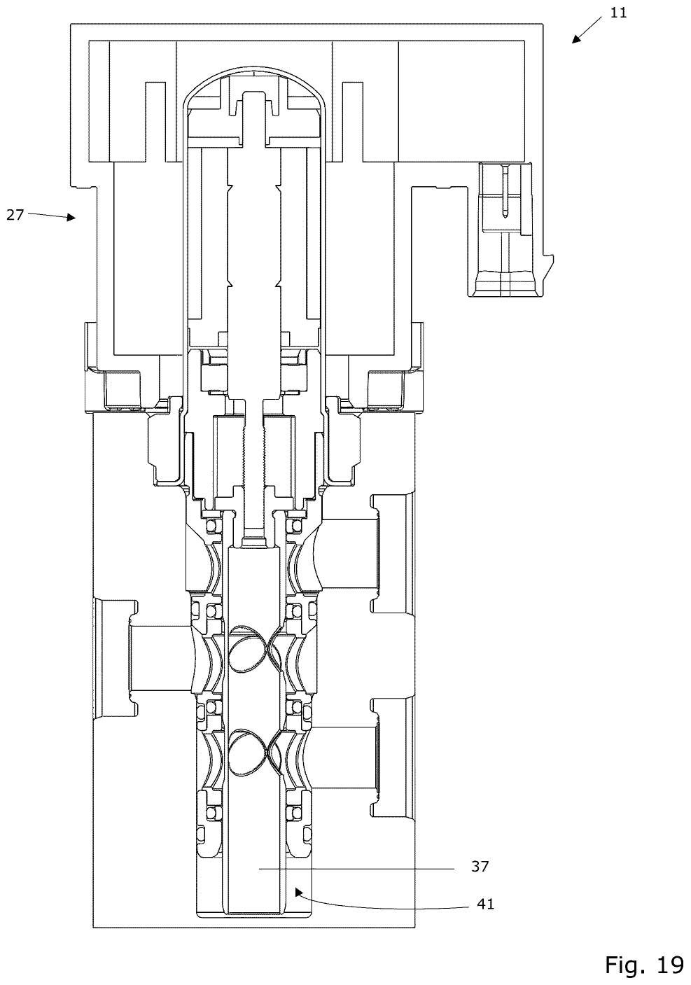

FIG. 19 a schematic sectional view of the embodiment of the multi-port valve according to FIG. 18 in a second end position,

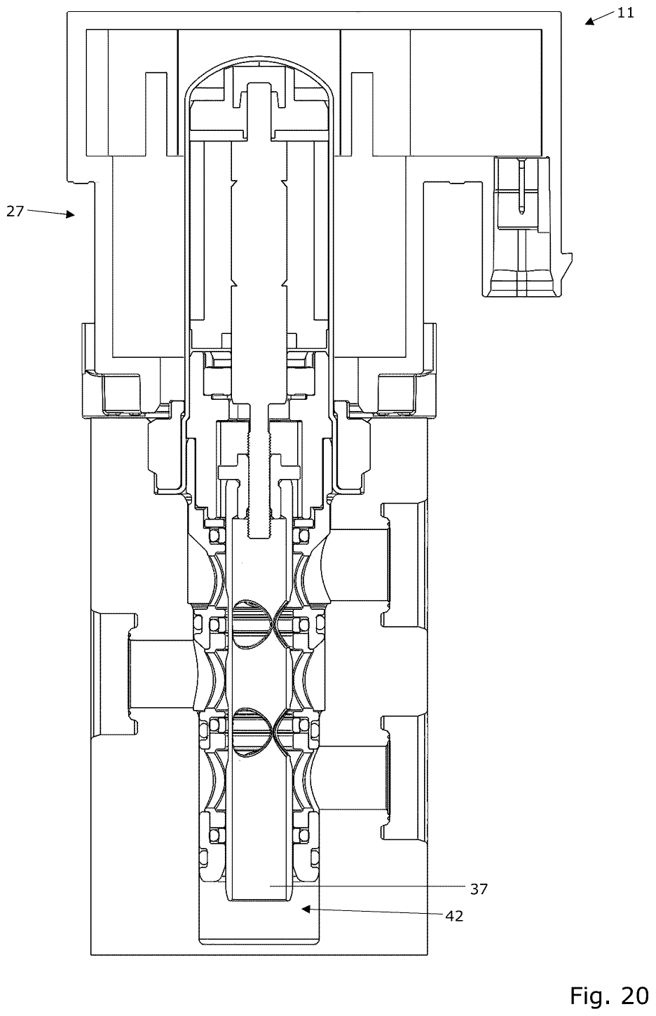

FIG. 20 a schematic view of the embodiment of the multi-port valve according to FIG. 18 in an intermediate position, and

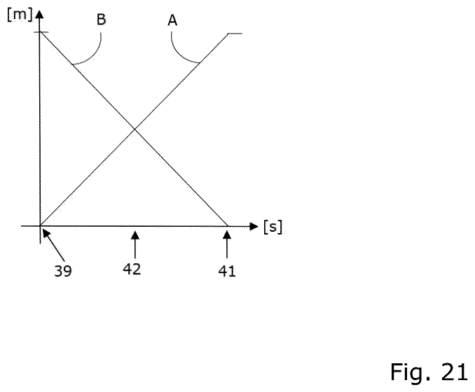

FIG. 21 a schematic diagram of the controllable volume flows according to the multi-port valve.

FIG. 1 shows a schematic sectional view of a multi-port valve 11. This multi-port valve 11 can be used to control a refrigerant circuit of a refrigeration system with a heat pump function. This multi-port valve 11 is designed, for example, as a three-way valve, which comprises an inlet 12 and a first outlet 14 as well as a second outlet 15. Alternatively, the multi-port valve 11 can also have several inlets and/or outlets.

The multi-port valve 11 is shown as an example in an installed position in a connection point 16. This connection point 16 comprises an insertion opening 17 into which the multi-port valve 11 can be inserted and connected to the connection point 16, in particular fastened with a detachable screw connection. An inlet opening 21 and a first and second outlet opening 22, 23 are provided in the connection point 16. The inlet opening 21 and the first and second outlet openings 22, 23 open into the insertion opening 17. This insertion opening 17 can also form a regulating chamber, which connects the inlet 12 and the first outlet 14 and the second outlet 15 to one another.

The multi-port valve 11 comprises a valve housing 25. This valve housing 25 is connected to an actuator 27. The actuator 27 is designed as an electrically controllable actuator 27. A connection 28 is provided for this purpose. This connection 28 can be used for the power supply and/or or for data transmission of electronics in the actuator 27, which are not shown in detail. The drive 27 is designed, for example, as a separating cap motor. It is preferable that the electronics of the drive 27 enable precise control of a stroke movement of a valve body 37. This actuation can be step-by-step or continuous. This makes it possible to control and assume a defined stroke position of the valve body 37. This actuator 27 comprises a stationary stator 31 and a rotor 32 that can be driven in rotation. A separating cap 33 is arranged between the stator 31 and the rotor 32. The separating cap 33 is arranged media-tight to the connection point 16 or to the insertion opening 17. The rotor 32 drives an actuating element 34 in rotation. The adjusting element 34 has a thread 35 on its outer circumference. The adjusting element 34 is secured in its position axially to the rotor 32 and rotates about its longitudinal axis. Alternatively, a proportional magnetic drive can also be provided, in particular with a magnetic armature position control or other electrically controllable drives.

The actuating element 34 extends through the valve housing 25. In particular, this actuating element 34 is positioned in a valve body chamber 36. The actuating element 34 is connected to a valve body 37. The valve body 37 is subjected to a stroke movement along its longitudinal axis by the adjusting element 34 or the actuator 27. The valve body 37 can be moved by the drive 27 from a first end position 39, which is shown for example in FIG. 1, to a second end position 41, which is shown in FIG. 2. In addition, the drive 27 also enables the valve body 37 to be moved to one or more intermediate positions 42, an intermediate position 42 being shown as an example in FIG. 3.

The valve body 37 is secured against rotation in relation to the control element 34 by an anti-rotation device 44. The anti-rotation device 44 can be moved within the valve body chamber 36. For example, a flattened portion or a spring, which is guided in a groove of the valve body chamber 36, or the like is provided on the outer circumference of the anti-rotation device 44.

A pressure bypass 46 is provided between the valve body 37 and the valve body chamber 36. This pressure bypass 46 is formed between the thread 35 of the actuating element 34 and the anti-rotation device 44, for example as a flattening on the actuating element 34. The pressure bypass 46 can also be formed between the anti-rotation device 44 and the valve body chamber 36.

The valve body 37 is tubular. The valve body 37 can be made of a plastic. The valve body 37 can also be made of a light metal alloy and other materials which are suitable for the use of various refrigerants. One end section of the valve body 37 is firmly connected to the control element 34 or the anti-rotation device 44. The valve body 37 has at least two through openings 48, 49. In the embodiment example, a first passage opening 48 is provided at the end face end of the tubular valve body 37. The further passage opening 49 is provided opposite and aligned in the radial direction and provided in the circumferential wall. The second passage opening 49 is formed, for example, by round recesses. One or more recesses distributed around the circumference can be provided on the tubular valve body 37, which form the passage opening 49. The through-openings 48, 49 can, for example, be designed as circular openings. They can also be polygonal or rectangular. In addition, the at least one passage opening 48, 49 can have a drop-shaped contour or an inflow section, so that with increasing stroke movement a changing, in particular a decreasing or increasing volume flow of the medium is released for outflow or inflow into the valve body 37 or can be controlled.

A first valve chamber sleeve 51 is arranged opposite the actuator 27 on the valve housing 25. This first valve chamber sleeve 51 is tubular in shape and surrounds the valve body 37. The first valve chamber sleeve 51 is preferably detachably attached to the valve housing 25. A first seal 52 is provided between the valve housing 25 and the first valve chamber sleeve 51. This first seal 52 has, for example, a sealing ring 53 directly adjacent to the outer circumference of the valve body 37. This sealing ring 53 can be made of PTFE, for example. The sealing ring 53 can be surrounded by an elastomer seal 54.

This arrangement can provide a seal between the actuator 27 and the valve body 37, which can be at least partially retracted into the valve body chamber 36. In addition, a seal can be created between a first pressure chamber 56, which is preferably formed in the connection point 16, in particular the insertion opening 17, and the actuator 27. At the same time, the detachable connection of the first valve chamber sleeve 51 to the valve housing 25 allows the first seal 52 to be fixed easily. The first seal 52 is preferably designed as a radially circumferential seal which engages on the outer circumference of the tubular valve body 37.

In this embodiment according to FIG. 1, the valve body 37 is freely protruding in relation to the first valve chamber sleeve 51. The multi-port valve 11 with the actuator 27, the first valve chamber sleeve 51 and the protruding valve body 37 is inserted into the connection point 16 as an installation unit. In the connection point 16, the first pressure chamber 56 is assigned to the second outlet 15, for example. A second pressure chamber 57 is provided adjacent to the first pressure chamber 56. This second pressure chamber 57 is assigned to the first outlet 14, for example. This second pressure chamber 57 is preferably positioned between the first pressure chamber 56 or the second outlet 15 and the inlet 12. A second seal 58 is preferably provided between the first and second pressure chambers 56, 57. This second seal 58 is preferably inserted into the insertion opening 17 separately from the multi-port valve 11 and is fixed in the connection point 16, for example with a fastening element 61, in particular a screw ring. This seals the first pressure chamber 56 from the second pressure chamber 57.

Furthermore, a third seal 62 is inserted into the insertion opening 17. This third seal 62 can be fixed in the insertion opening 17 by the fastening element 61 in the same way as the second seal 58. This third seal 62 seals the second pressure chamber 57 from the inlet 12 and the first outlet 14.

To position the multi-port valve 11 in the insertion opening 17 of the connection point 16, the valve body 37 is preferably moved to the first end position 39. This first end position 39 means that the valve body 37 is moved into a maximum stroke position by the actuator 27 relative to the valve housing 25. The valve body 37 is first inserted into the second seal 58 and then into the third seal 62. Subsequently, the actuator 27 is firmly connected to the connection point 16 by a preferably detachable screw connection. For example, an axial seal 64 is provided at this interface.

The multi-port valve 11 is shown with the valve body 37 in the first end position 39 in the connection point 16 in a first switching position. In this first switching position, the inlet 12 is connected to the first passage opening 48 and the second passage opening 49 is connected to the second outlet 15, so that the volume flow of the medium is completely transferred from the inlet 12 to the second outlet 15. The tubular valve body 37 extends completely between the second seal 58 and the third seal 62, so that the first outlet 14 is blocked.

In this embodiment of the multi-port valve 11, it is provided that the length of the valve body 37 is designed such that, when the valve body 37 is positioned in the first end position 39 of the valve body 37, it extends from the first seal 52 along the second seal 58 into the third seal 62. As a result, the valve body 37 is guided in the first seal 52, the second seal 58 and the third seal 62

The first seal 52 is understood to be the seal which is arranged between the first pressure chamber and the valve housing.

The second seal 58 is understood to be the seal which is arranged between the first pressure chamber and the second pressure chamber or which separates the first pressure chamber from the second pressure chamber.

The third seal 62 is understood to be the seal positioned between the inlet and a downstream pressure chamber.

Due to this arrangement of the multi-port valve 11 according to FIG. 1, it is also possible for the pressure of the medium applied to the inlet 12 to be applied to the valve body chamber 36 via the pressure bypass 46. Based on this, a reduced actuating force of the actuator 27 is required to move the valve body 37 from a first end position 39 according to FIG. 1 to the second end position 41 according to FIG. 2.

In this second end position 41, a free end face end of the valve body 37 is led out of the third seal 62. The end face end of the valve body 37 is arranged within the second pressure chamber 57. From there, the tubular valve body 37 extends continuously to the first seal 52. As a result, the second outlet 15 is blocked. A free passage is formed between the inlet 12 and the first outlet 14. A flow of the medium from the second pressure chamber 57 into the first pressure chamber 56 is prevented by the second seal 58.

The valve body 37 preferably has an insertion slope at its front end so that the front end of the valve body 37 can be securely reinserted into the third seal 62.

FIG. 3 shows a further schematic sectional view of the multi-port valve 11 according to FIG. 1, whereby the valve body 37 is arranged in the intermediate position 42. In this intermediate position 42, it is provided that the inlet 12 supplies both the first outlet 14 and the second outlet 15 with the medium. For example, it is provided that the end face end of the valve body 37 is again raised relative to the third seal 62. At the same time, however, a stroke position is assumed in which the passage opening 49 is still positioned within the first pressure chamber 56, so that a volume flow can flow into the second outlet 15.

Depending on the arrangement of the passage opening 48, which is assigned to the first pressure chamber 56, as well as an end face end of the valve body 37, the volume flows for the first outlet 14 and/or the second outlet 15 can be controlled and distributed as a percentage.

In this embodiment, the multi-port valve 11 can be designed as an assembly which also comprises the second seal 58 and the third seal 62, each of which can be inserted and fixed separately in the connection point 16. Fastening elements 61 for the seals 58, 62 can also be included.

According to an alternative embodiment of the multi-port valve 11 according to FIGS. 1 to 3, which is not shown in detail, it may be provided that, for example, the second seal 58 and the third seal 62 form a second valve chamber sleeve 66. This second valve chamber sleeve 66 can be inserted into the second pressure chamber 57 and comprises the second seal 58 and third seal 62 at the respective end. This second valve chamber sleeve 66 can be inserted into the connection point 16 separately from the multi-port valve 11 and can be fixed therein. Preferably, the second valve chamber sleeve 66 in each case comprises a seal 67 on the outside of the second seal 58 and third seal 62, which is aligned with the insertion opening 17.

According to a further embodiment of the multi-port valve 11 according to FIGS. 1 to 3, which is not shown in more detail, it may be provided that the first valve chamber sleeve 51 extends along the first pressure chamber 56. In this case, the first seal 52 and the second seal 58 are fixed to the first valve chamber sleeve 51. The third seal 62 can be inserted separately into the connection point 16 and detachably fixed by the fastening element 61.

FIGS. 4 to 6 show an alternative embodiment of the multi-port valve 11 to the embodiments described above. In this embodiment of the multi-port valve 11, it is provided that the first valve chamber sleeve 51 and the second valve chamber sleeve 66 are connected to each other and the first valve chamber sleeve 51 is attached to the valve housing 25. In this embodiment, it is preferably provided that the second seal 58 is positioned and fixed in the interface between the first valve chamber sleeve 51 and the second valve chamber sleeve 66. At the same time, a seal 67 is provided in the interface between the first and second valve chamber sleeves 51, 66 on the outer circumference of the interface. This seal 67 is accommodated on the first valve chamber sleeve 51 or the second valve chamber sleeve 66, preferably in a circumferential groove, depending on whether the first valve chamber sleeve 51 surrounds the second valve chamber sleeve 66 on the outside or vice versa. At the free end face end of the second valve chamber sleeve 66, a seal 67 is also provided circumferentially on the outside.

The multi-port valve 11 thus comprises the actuator 27, the valve housing 25, the valve body 37 and a cartridge housing 68, which is composed at least of the first valve chamber sleeve 51 and the second valve chamber sleeve 66, with the second seal 58 being arranged between the first and second valve chamber sleeves 51, 66 and the third seal 62 being arranged at the end face of the second valve chamber sleeve 66. Thus, the multi-port valve 11 with the cartridge housing 68 can be inserted as a single unit into the insertion opening 17 of the connection point 16.

Reference can also be made to the explanations in FIGS. 1 to 3 for the mode of operation of the multi-port valve 11

FIG. 7 shows a schematic view of a further alternative embodiment of the multi-port valve 11 to the above embodiments. This embodiment differs in the design of the valve body 37 from the embodiments described above. In this embodiment, it is provided that the valve body 37 can be shortened even further compared to the above embodiments. This is due to the fact that the through-openings 49, which are provided radially in the circumferential wall of the valve body 37 in the above embodiments, are omitted. In this valve body 37, it is provided that the at least one passage opening 49 is formed at an end face end at which the valve body 37 is connected to the actuating element 34. This passage opening 49 is, for example, star-shaped, as can be seen in the perspective view in FIG. 8. For example, at least one web 69 at least one rib, preferably two or three webs or ribs, can be provided, between which the at least one through-opening 49 or the through-openings 49 extend. The circumferential wall of the valve body 37 is thus completely closed.

The shortened length of the valve body 37 can be seen from the view shown in FIG. 7. On the one hand, one end face end of the valve body 37, in which the passage opening 48 is provided, is positioned in the third seal 62. The opposite end of the valve body 37 can end between the first and second pressure chambers 56, 57. The medium can pass directly from the inlet 12 into the first pressure chamber 56 and then into the second outlet 15 through the end opening 49, which points in the direction of the actuator 27.

FIG. 9 shows a schematic sectional view of the multi-port valve 11 according to FIG. 7 in the second end position 41 of the valve body 37. FIG. 10 shows a schematic sectional view of the multi-port valve 11 according to FIG. 7, in which the valve body 37 is arranged in the intermediate position 42. The protruding design of the valve body 37 with the two opposing end openings 48, 49 can also be used in the embodiments described above.

FIG. 11 shows a schematic sectional view of a further alternative embodiment of the multi-port valve 11 to the above embodiments according to FIGS. 1 to 10. This multi-port valve 11 differs in the design of the third seal 62 from the embodiment according to FIGS. 4 to 6. In FIGS. 1 to 10, the third seal 62 is designed as a radial seal. In the multi-port valve 11 according to FIG. 11, the third seal 62 is designed as an axial seal. It is provided that this seal 62 points in the direction of an end face of the valve body 37. When the valve body 37 is transferred to the first end position 39 by a lifting movement, an end-face annular surface of the valve body 37 comes into sealing contact with the axial seal 62. This axial seal 62 can be arranged in a retaining ring 65 and held securely in the retaining ring 65, for example by a beading. This receiving ring 65 can be inserted, pressed into or integrated into the second valve chamber sleeve 66. This third seal 62 can be surrounded by an external circumferential seal 67. In this embodiment of the multi-port valve 11, it is provided that, during a stroke movement between the first end position 39 and the second end position 41, the valve body 37 is guided by the radial first seal 52 and by the radial second seal 58 and, in the first end position 39, rests sealingly on the third seal 62, which is designed as an axial seal.

Reference can be made to FIGS. 1 to 10 with regard to the further designs and embodiments of the multi-port valve 11 in FIG. 11.

This third seal 62, which is designed as an axially aligned seal, can also be used in the embodiment of the multi-port valve 11 according to FIGS. 1 to 3 as well as in the alternative embodiments described with respect thereto.

FIGS. 12 to 14 show a further alternative embodiment of the multi-port valve 11. FIG. 12 shows the multi-port valve 11 in a first end position 39. FIG. 13 shows the multi-port valve 11 according to FIG. 12 in a second end position 41 and FIG. 14 shows the multi-port valve 11 according to FIG. 12 in an intermediate position 42. In this embodiment, it is provided that the tubular valve body 37 corresponds to the embodiment according to FIGS. 7 to 10. The further structure of this embodiment also corresponds to the embodiment according to FIGS. 7 to 10. Deviating from the present embodiment according to FIGS. 12 to 14, it is provided that the first seal 52 and the third seal 62 are each designed as an axial seal. This means that one end face of the valve body 37 is in sealing contact with the first seal 52 or third seal 62 both in the first end position 39 and in the second end position 41. In between, the second seal 58 is designed as a radial seal, whereby the valve body 37 is displaceably guided during the travel movement between the first end position 39 and the second end position 41. As an alternative to this embodiment, it can also be provided that the first seal 52 is designed as a radial seal and only the third seal 62 is designed as an axial seal. An interchanged arrangement can also be provided.

FIGS. 15 to 17 show an alternative embodiment of the multi-port valve 11 to the embodiments described above. In this embodiment of the multi-port valve 11, it is provided that the tubular valve body 37 has a longer extension than is the case in the embodiments described above. In FIG. 15, the valve body 37 is positioned in the first end position 39 in analogy to FIG. 4. As a result, the medium flows from the inlet 12 through the valve body 37 and exits via the passage opening 49 into the second outlet 15. FIG. 16 shows the multi-port valve 11 with the valve body 37 in the second end position 41. In this second end position 41, the inlet 12 is connected to the first outlet 14. The outflow of the medium into the second outlet 15 is blocked.

In this embodiment, it is provided that, due to the greater length of the valve body 37, during a stroke movement of the valve body 37 from the first end position 39 to the second end position 41, it is guided in the first to third seals 52, 58, 62. Thus, the valve body 37 does not come free relative to the third seal 62. This longer version of the valve body 37 can also be provided in the alternative embodiments described above and not shown in more detail.

FIG. 17 shows the multi-port valve 11 as shown in FIGS. 15 and 16 with the valve body 37 in the intermediate position 42. The volume flow of the medium, which enters the through-opening 48 of the valve body 37 via the inlet 12, can thus flow out via the further through-opening 49 into the first and second pressure chambers 56, 57.

FIGS. 18 to 20 show a further alternative embodiment of the multi-port valve 11. This multi-port valve 11 is adapted with respect to the valve body 37 in such a way that at least one laterally arranged inlet 12 and also laterally arranged outlets 14, 15 are provided in the connection point 16. In the embodiments described above according to FIGS. 1 to 10, 15 to 17, the inlet 12 is provided on an end face of the connection point 16, whereas the outlets 14, 15 are arranged on a side wall arranged at right angles thereto. The connections 14, 15 can be arranged on the same side wall or on opposite side walls as the inlet 12.

In the above embodiment according to FIGS. 18 to 20, it is provided that the outlets 14, 15 are arranged on a side wall of the connection point 16 and that the at least one inlet 12 is arranged on a further or opposite side wall, in particular not on an end face of the connection point 16. Advantageously, the inlet 12 is positioned between the two outlets 14, 15. Due to this arrangement of the inlet 12 and the outlets 14, 15, the valve body 37 comprises, for example, three passage openings 48, 49, 50. Preferably, two passage openings 48, 49 are provided in the radial circumferential wall, spaced apart from one another. These two passage openings 48, 49 are arranged at a distance from one another which corresponds to a distance between the inlet 12 and the first outlet 14 as viewed in the stroke direction of the valve body 37. Advantageously, the distance between the inlet 12 and the second outlet 15 is identical to the distance between the inlet 12 and the first outlet 14 as viewed in the stroke direction.

The length of the valve body 37 is such that it can be moved from a first end position 39 as shown in FIG. 18 to a second end position 41 as shown in FIG. 19. In the first end position 39 as shown in FIG. 18, the inlet 12 is connected to the first outlet 14 and the second outlet 15 is blocked. In the second end position 41 of the valve body 37 as shown in FIG. 19, the first outlet 14 is blocked and the second outlet 15 is connected to the inlet 12. FIG. 20 shows the valve body 37 in one intermediate position 42, so that both outlets 14, 15 can be supplied with the medium flowing into the inlet 12.

In this embodiment, it is provided that the valve body 37 is permanently guided by the first seal 52, by two third seals 62 and, for example, by a fourth seal 71

The fourth seal is understood to be a further seal which is provided in addition to a pressure chamber for sealing the pressure chamber on one side. In this embodiment of the multi-port valve 11, it is provided that the first seal 52 seals the first pressure chamber 56 to the valve housing 25. The third seal 62 seals the first pressure chamber 56 to the inlet 12. The further third seal 62 in turn seals the inlet 12 to the second pressure chamber 57. Preferably, the fourth seal 71 is also provided in this embodiment. This fourth seal 71 can additionally be used to seal and/or guide the valve body 37, which is open, for example, through the end-face passage opening 50. In this embodiment, a third pressure chamber 72 is preferably provided between the inlet 12 on the one hand and the first and second outlets 14, 15 on the other hand. In the embodiment shown in FIGS. 18 to 20, a cartridge housing 68 is provided, which is composed of the first valve chamber sleeve 51, the second valve chamber sleeve 66 and a third valve chamber sleeve 74. The third valve chamber sleeve 74 is constructed in analogy to the second valve chamber sleeve 66 and adjoins the second valve chamber sleeve 66.

Alternatively, it may be provided that in this embodiment of the connection point 16, the second to fourth seals 58, 62 and 71 are each inserted and fastened separately in the insertion opening 17. Alternatively, it may be provided that the first and second seals 52, 58 are received by the first valve chamber sleeve 51 and the third seal 66 and fourth seal 71 are inserted into the connection point 16. It may also be provided that only the fourth seal 71 is inserted separately into the connection point 16 and the first to third seals 52, 58 and 62 are attached to or received in the valve chamber sleeves 51, 66.

In all the embodiments of the multi-port valve 11 provided, reversed actuation is also possible, so that the two outlets are actuated as two inlets and one inlet serves as an outlet.

FIG. 21 schematically shows a diagram in which the controllable volume flows through the multi-port valve 11 according to one of the above embodiments are shown. In the diagram, the volume flows are shown as a function of the stroke path of the valve body 37. The stroke path of the valve body 37 between the first end position 39 in the second end position 41 is plotted along the X-axis. The Y-axis shows the volume flow of the medium as a function of the movement of the valve body 37 of the first outlet 14 (characteristic curve A) and the second outlet 15 (characteristic curve B). The multi-port valve 11 is designed in such a way that it releases a complete volume flow for the medium in an end position 39 or 41. In the end position 39, the volume flow between the inlet 12 and the second outlet 15 is completely open and the first outlet 14 is blocked. In the second end position 41, the volume flow between the inlet 12 and the first outlet 14 is fully open and the volume flow between the inlet 12 and the second outlet 15 is blocked. In the intermediate position 42, mixed operation can be enabled depending on the stroke path of the valve body 37, whereby, for example, one volume flow continuously decreases and the other volume flow continuously increases. A non-linear decrease or increase or a mixture thereof can also be controlled.

1. Multi-port valve for controlling a medium, in particular in a refrigerant circuit of a refrigerant system with a heat pump function,
with a drive,
with a valve body, a stroke movement of the valve body along a stroke axis is controllable by an actuating element of the drive,
with a valve body chamber facing the drive, into which the valve body is at least partially moveable,
wherein
the valve body is tubular and extends along the stroke axis, and
the valve body, in an end position of the stroke movement, passes through at least one first pressure chamber between an inlet and an outlet and projects into or passes through at least one second pressure chamber between the inlet and at least one further outlet, wherein at least one seal is associated with each pressure chamber for abutment against the valve body.

2. Multi-port valve according to claim 1, wherein the tubular valve body has at least two passage openings, a first passage opening being assigned to an inlet and the at least one further passage opening being assigned to the at least one outlet.

3. Multi-port valve according to claim 1, wherein a stop is provided in each case for the stroke movement of the valve body into the first end position and the one second end position.

4. Multi-port valve according to claim 3, wherein the valve body connects the inlet and the one outlet in the first end position of the valve body and connects the inlet to the one further outlet in the second end position.

5. Multi-port valve according to claim 1, wherein a pressure bypass is provided between the valve body and the valve body chamber.

6. Multi-port valve according to claim 1, wherein at least one seal assigned to the pressure chambers is designed as a radial seal which bears against an outer circumference of the tubular valve body, or in that at least one seal assigned to the pressure chambers is designed as an axial seal against which an end face of the tubular valve body bears in a sealing manner in the one end position, or in that at least one radial seal and at least one axial seal are provided, against which the tubular valve body bears in a sealing manner in at least one of the end positions.

7. Multi-port valve according to claim 1, wherein a first seal is provided between the drive and the first pressure chamber, a second seal is provided between the first and the second pressure chamber and a third seal is provided between the inlet and the second pressure chamber.

8. Multi-port valve according to claim 7, wherein the valve body has a length such that the valve body is guided in the first to third seals in the first end position and is guided only in the first and second seals in the second end position, or in that the valve body has a length such that the valve body is guided in the second and third seals in the first end position and is raised with respect to the first seal and is guided only in the first and second seals in the second end position and is raised with respect to the third seal, or in that the valve body has a length, so that the valve body is guided through the second seal in the first and second end positions and preferably the second seal is designed as a radial seal and the first and third seals are designed as radial and/or axial seals.

9. Multi-port valve according to claim 7, wherein the tubular valve body has a length such that the valve body is guided in the first to third seal in the first end position and in the second end position, an additional passage opening to the second passage opening being provided in the circumferential wall and/or on an end face of the valve body.

10. Multi-port valve according to claim 1, wherein a first seal is provided between the drive and the first pressure chamber, a third seal is provided between the inlet and the second pressure chamber and a fourth seal is assigned to the second pressure chamber, which is provided opposite the third seal, which is also adjacent to the second pressure chamber.

11. Multi-port valve according to claim 10, wherein the valve body extends from the passage opening assigned to the inlet on both sides in the direction of the respective outlet and is guided at least inside the first and third seals.

12. Multi-port valve according to claim 1, wherein the tubular valve body is round or oval in cross-section.

13. Multi-port valve according to claim 1, wherein a first valve chamber sleeve is assigned to the drive, which extends in the opposite direction to the drive and surrounds the valve body and is assigned to a first pressure chamber, the first seal, which seals the first pressure chamber to the drive, being accommodated between the first valve chamber sleeve and the drive.

14. Multi-port valve according to claim 13, wherein the first valve chamber sleeve extends through the first pressure chamber and receives the second seal, which is associated opposite the first seal of the first pressure chamber and preferably the second seal separates the first pressure chamber from the second pressure chamber.

15. Multi-port valve according to claim 13, wherein the first valve chamber sleeve is adjoined by a second valve chamber sleeve which extends through the second pressure chamber, wherein the second seal is received in an interface between the first valve chamber sleeve and the second valve chamber sleeve and the second valve chamber sleeve receives the third seal opposite the first valve chamber sleeve, which seal seals the second pressure chamber with respect to the inlet.

16. Multi-port valve according to claim 1, wherein a third valve chamber sleeve is provided between the second valve chamber sleeve and the first valve chamber sleeve, which is assigned to the inlet positioned between the first outlet and the at least one further outlet.

17. Multi-port valve according to claim 16, wherein each valve chamber sleeve is designed in one or more parts and at least the radial seal facing the valve body is provided in an interface between two valve chamber sleeves or in an interface of the multi-part valve chamber sleeve or in an interface between the valve chamber sleeve and the drive, and at least one seal is provided on the outside of the interface.

18. Multi-port valve according to claim 16, wherein the first and at least one further valve chamber sleeve are non-detachably connected to one another to form a cartridge housing and is insertable together into an insertion opening of a connection point.

19. Multi-port valve according to claim 1, wherein the valve body is insertable into an insertion opening of a connection point, the connection point having an inlet and at least two outlets which are selectively actuatable by the movement of the valve body.

20. Multi-port valve according to claim 1, wherein the multi-port valve is designed as a 3/2-way valve, which is provided in particular for a refrigerant R744 or R290.
